(19) United States
(12) Patent Application Publication
(10) Pub. No.: US 2005/0266980 A1
(43) Pub. Date: Dec. 1, 2005

(54) Process of producing a novel MEA with enhanced electrode/electrolyte adhesion and performancese characteristics

(76) Inventors: Arunachala Nadar Mada Kannan, Honolulu, HI (US); Tony Mathew Koshy Thampan, Honoululu, HI (US)

Correspondence Address: DECHERT LLP, P.O. BOX 10004, PALO ALTO, CA, 94303, US

(21) Appl. No.: 10/857,573

(22) Filed: May 28, 2004

(51) Int. Cl. H01M 4/88; B05D 5/12; H01M 4/86

(52) U.S. Cl. 502/101; 427/115; 429/40

(57) ABSTRACT

A process for producing a catalyzed membrane is described. The process includes mixing components of a catalyst to produce a catalyst mixture, wherein one of the component includes an aprotic solvent and applying the catalyst mixture to a membrane to produce the catalyzed membrane.

### FIELD OF THE INVENTION

The present invention relates to a membrane electrode assembly (“MEA”). More particularly, the present invention relates to a process for assembling a thermoplastic based MEA, which yields high performance and provides good adhesion between the electrodes and the electrolyte in fuel cell applications.

### BACKGROUND OF THE INVENTION

With the growing need for energy in the presence of limited fossil fuel supply, the demand for environmentally friendly and renewable energy sources is increasing. Fuel cell technology, a promising source of clean energy production, is a leading candidate to meet the growing need for energy. Fuel cells are efficient energy generating devices that are quiet during operation, fuel flexible (i.e., have the potential to use multiple fuel sources), and have co-generative capabilities (i.e., can produce electricity and usable heat, which may ultimately be converted to electricity). Of the various fuel cell types, the proton exchange membrane fuel cell (PEMFC) has the greatest potential. PEMFCs can be used for energy applications spanning the stationary, portable electronic equipment and automotive markets.

At the heart of the PEMFC is a fuel cell membrane (hereinafter “proton exchange membrane”), which separates the anode and cathode compartments of the fuel cell. The proton exchange membrane controls the performance, efficiency, and other major operational characteristics of the fuel cell. As a result, the membrane should be an effective gas separator, effective ion conducting electrolyte, have a high proton conductivity in order to meet the energy demands of the fuel cell, and have a stable structure to support long fuel cell operational lifetimes. Moreover, the material used to form the membrane should be physically and chemically stable enough to allow for different fuel sources and a variety of operational conditions.

Currently, many fuel cell membranes are formed from perfluorinated sulfonic acid (“PFSA”) materials. A commonly known PFSA membrane is Nafion® and is commercially available from DuPont.

Nafion® and other similar perfluorinated membrane materials manufactured by companies such as W. L. Gore and Asahi Glass (described in U.S. Pat. Nos. 6,287,717 and 6,660,818 respectively) show high oxidative stability as well as good performance when used with pure hydrogen fuel. Unfortunately, these perfluorinated membrane materials are expensive to manufacture which limits fuel cell commercialization.

Making perfluorinated ionomer materials require complex monomer and polymerization reactions. These reactions are often time consuming, hazardous, and low yielding. Furthermore, these reactions are cost prohibitive, i.e., currently contribute to the costs as much as about $500 per m².

To overcome these cost and performance limitations, alternative polymer materials, such as poly(benzimidazole) (“PBI”), polyvinylidene fluoride (“PVDF”), styrene based co-polymers, and aromatic thermoplastics have been actively researched. To date, the most promising of these alternative materials has been acid functionalized aromatic thermoplastics.

Aromatic thermoplastics such as poly(ether ether ketone) (“PEEK”), poly(ether ketone) (“PEK”), poly(sulfone) (“PSU”), poly(ether sulfone) (“PES”), are promising candidates as fuel cell membranes due to their low cost, high mechanical strength, and good film forming characteristics. When functionalized with sulfonic acid groups, these materials have exhibited acceptable fuel cell performance and low methanol crossover.

Processing such thermoplastic materials into high quality MEAs, however, is difficult as the electrode layers do not adhere adequately to the electrolyte membranes. Poor adhesion leads to untapped performance potential during fuel cell operation. Poor electrode-electrolyte adhesion may be attributed to several characteristics. These include, for example, high glass transition temperatures (“Tg”), ionomer incompatibilities in the catalyst layer, and the MEA assembly process.

Several research groups have attempted to solve the problem of limited adhesion at the electrode-electrolyte interface. McGrath et al. employed a decal method where a catalyst ink is first applied to a non-functional substrate. The substrate is then transferred onto the electrolyte membrane surface at a specified temperature and pressure. This procedure transfers the catalyst layer to the membrane surface. However, to get effective adhesion between the catalyst layer and membrane, the press temperature must be at or higher than the Tg of the polymer. The challenge is that the Tg for most thermoplastic polymers is above the point at which the polymer starts to desulfonate. Partial or full desulfonation limits fuel cell performance regardless of the electrode-electrolyte interface. Other methods have focused on lowering the Tg of the ionomer materials used in the catalyst layer to try and adhere onto the higher Tg thermoplastic membranes. This has been met with only limited success as the differences in Tg make proper adhesion difficult.

Unfortunately, the rigid structure and resulting thermal properties of thermoplastic based materials continue to cause limited MEA adhesion and lower fuel cell performance in certain instances. What is therefore needed is an improved MEA or process for making the same, which is cost effective, high performing, easily processed and minimizes adhesion problems.

### SUMMARY OF THE INVENTION

To achieve the foregoing, the present invention provides a process for producing a catalyzed membrane. The process includes: (1) mixing components of a catalyst to produce a catalyst mixture, which components include an aprotic solvent and applying the catalyst mixture to a membrane to produce the catalyzed membrane.

In another aspect the present invention provides a membrane electrode assembly (“MEA”) for fuel cell application. The MEA includes a catalyzed membrane, which in turn includes a cathode catalyst layer and an anode catalyst layer. Furthermore, the catalyzed membrane is produced by steps including mixing components of a catalyst to produce a catalyst mixture, wherein one of the components includes an aprotic solvent, and applying the catalyst mixture to a membrane to produce the catalyzed membrane.

These and other features of the present invention will be described in more detail below in the detailed description of the invention and in conjunction with the following figures.

### BRIEF DESCRIPTION OF THE DRAWINGS

FIG. 1 is a diagram of a fuel cell which has incorporated into it a membrane electrode assembly (“MEA”), according to one embodiment of the present invention.

FIG. 2 shows a cross-sectional view of the membrane electrode assembly shown in FIG. 1.

FIG. 3 is a general structure of a preferred proton exchange material, according to one embodiment of the present invention.

FIG. 4 shows a structure of a preferred proton exchange material, according to another embodiment of the present invention.

FIG. 5 shows a scanning electron microscope (“SEM”) image of a MEA using a conventional MEA assembly process.

FIG. 6 shows a SEM image of a MEA produced using the inventive MEA assembly process.

FIG. 7 shows a comparative plot illustrating fuel cell performance of a conventional MEA relative to a MEA produced by an embodiment of the inventive process.

FIG. 8 shows another comparative plot illustrating fuel cell performance of a conventional MEA and another MEA produced by another embodiment of the inventive process.

### DETAILED DESCRIPTION OF THE PREFERRED EMBODIMENTS

The present invention provides a process for producing a membrane electrode assembly (“MEA”) which can be used in electrochemical devices, such as fuel cells. The MEA is prepared according to the inventive steps of the present invention has better adhesive properties, allowing for construction of higher performance MEAs than those found in conventional MEAs. In the following description of the inventive process of producing such MEAs numerous specific details are set forth below in order to fully illustrate a preferred embodiment of the present invention. It will be apparent, however, that the present invention may be practiced without limitation to some specific details presented herein.

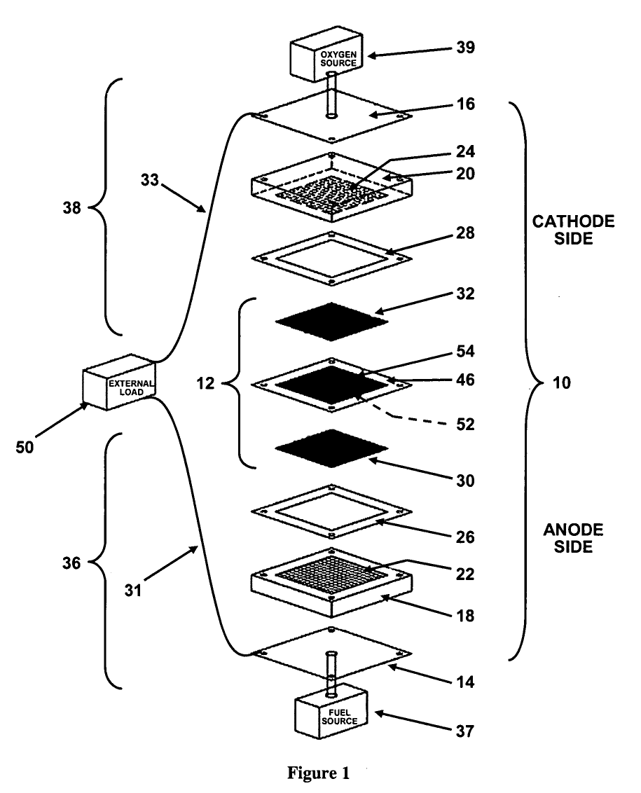

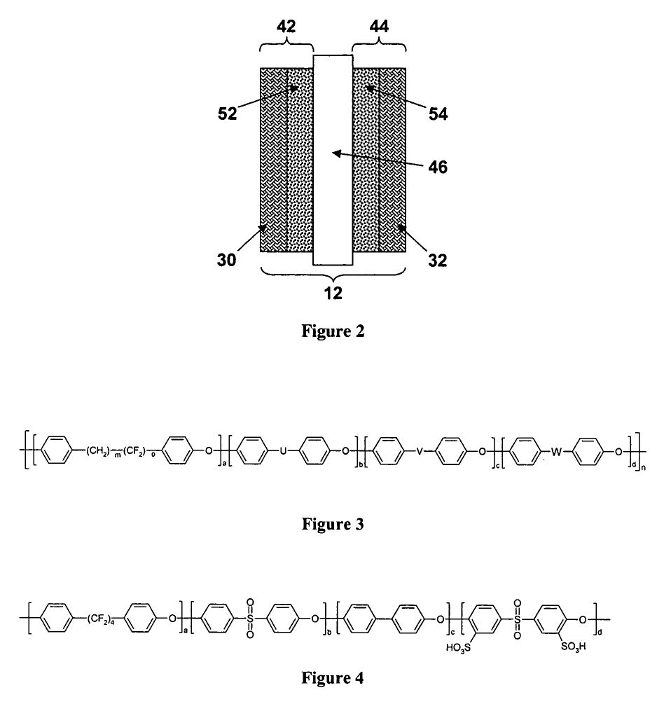

FIG. 1 shows a fuel cell 10 that has incorporated into it a MEA 12, in accordance with one embodiment of the present invention. MEA 12 includes a proton exchange membrane 46, which is also shown in FIG. 2. It should be, however, noted that the application of inveritive MEAs are not limited to the fuel cell configuration shown in FIG. 1, rather they can also be effectively employed in conventional fuel cell applications described in U.S. Pat. No. 5,248,566 and 5,547,777, for example. Furthermore, several fuel cells may be connected in series by conventional techniques to create fuel cell stacks, which contain at least one of the inventive membranes.

As shown in FIG. 1, electrochemical cell 10 generally includes an MEA 12 flanked by anode and cathode structures. On the anode side, fuel cell 10 includes an endplate 14, graphite block or bipolar plate 18 with openings 22 to facilitate gas distribution, gasket 26, and anode gas diffusion layer (“GDL”) 30. On the cathode side, fuel cell 10 similarly includes an endplate 16, graphite block or bipolar plate 20 with openings 24 to facilitate gas distribution, gasket 28, and cathode GDL 32.

Anode end plate 14 and cathode end plate 16 are connected to external load 50 by leads 31 and 33, respectively. External load 50 can comprise any conventional electronic device or load such as those described in U.S. Pat. Nos. 5,248,566, 5,272,017, 5,547,777, and 6,387,556, which are incorporated herein by reference for all purposes. The electrical components can be hermetically sealed by techniques well known to those skilled in the art.

During operation, in fuel cell 10 of FIG. 1, fuel from fuel source 37 (e.g., container or ampule) diffuses through the anode and oxygen from oxygen source 39 (e.g., container, ampule, or air) diffuses through the cathode of the MEA. The chemical reactions at the MEA generate electricity that is transported to the external load. Hydrogen fuel cells use hydrogen as the fuel and oxygen (either pure or in air) as the oxidant. For direct methanol fuel cells, the fuel is liquid methanol.

Endplates 14 and 16 are made from a relatively dimensionally stable material. Preferably, such material includes one selected from the group consisting of metal and metal alloy. Bipolar plates, 20 and 22, are typically made from any conductive, corrosion resistant material selected from the group consisting of graphite, carbon, metal and metal alloy. Gaskets, 26 and 28 are typically made of any material selected from the group consisting of Teflon®, fiberg lass, silicone, rubber and similar materials. GDLs, 30 and 32, are typically made from a porous electrode material such as carbon cloth or carbon paper. Furthermore, GDLs 30 and 32 may contain some sort of dispersed carbon based powder to facilitate gas movement.

FIG. 2 shows a side-sectional view of MEA 12, which is incorporated into fuel cell 10 of FIG. 1. As shown in this embodiment, MEA 12 includes a proton exchange membrane 46 that is flanked by anode 42 and cathode 44. On the anode side, MEA 12 includes a GDL 30, and an anode catalyst layer 52. On the cathode side, MEA 12 similarly includes a GDL 32, and a cathode catalyst layer 54. Cathode catalyst layer 54, proton exchange membrane 46 and anode catalyst layer 52 collectively form a catalyzed membrane. Proton exchange membrane 46 may include perfluorinated sulfonic acid (“PFSA”) based membranes, such as Nafion® by DuPont, Aciplex® by Asahi Chemical, Gore Select® by W. L. Gore and others. These are described in U.S. Pat. Nos. 3,784,399, 4,042,496, 4,330,654, 5,221,452 and 2003/0153700. Additionally, non PFSA membranes made from such materials as thermoplastics are well suited due to their lower costs and performance characteristics. Conventionally available thermoplastics including poly(ether ether ketone) (“PEEK”), poly(ether ketone) (“PEK”), poly(sulfone-udel) (“PSU”), and poly(ether sulfone) (“PES”), as well as custom engineered thermoplastics such as polyarylene ether ketones, polyarylene sulfones, polynaphthalenimides and polybenzimidazoles (“PBI”) types may also be utilized as proton exchange membranes. However, a preferred embodiment of the proton exchange material has a general structure shown in FIG. 3.

In the polymer embodiment of FIG. 3, repeat unit “a” varies from about 0.1% to about 100% molar percent and the number of repeat units “b,” “c,” and “d” may all vary from about 0 to about 50%. U, V and W are functional groups selected from the group consisting of sulfones, ketones, carbon-carbon bonds, branched carbon based structures, alkenes, alkynes, amides, and imides. In alternative embodiments of the present invention, the above-identified polymer includes G and G′ on some or all the aromatic rings shown above. G and G′ independently are one selected from the group consisting of sulfonic acids, phosphoric acids, carboxylic acids, sulfonamides and imidazoles, and may be situated on the ortho or meta, positions to the either, U, V, or W. Furthermore, G and G′ may be fluorinated or nonfluorinated aliphatic chains containing one or more of the aforementioned group compounds. Integer values “m” and “o” are between 0 and 15. Integer “m” ranges between 0 and 15 and integer “o” ranges between 1 and 15. When integer “o” equals zero, integer m” can equal one of 3, 4, 5, 7, 8, 9, 10, 11, 12, 13, 14, and 15.

The anode and cathode electrode components of the inventive MEA typically comprise of porous catalyst layers, 52 and 54, adhered to the surface of the polymer electrolyte membrane. The porosity of the electrode should allow gaseous reactants to diffuse through the bulk of the electrode at electrochemically usable rates. Preferred catalysts are formed of electrically conductive materials, preferably particulate in nature, and may contain catalytic materials held together by a polymeric binder. Catalytic materials include supported or unsupported transition metal or transition metal alloys. Representative transition metals or transition metal alloys include at least one material selected from the group consisting of Pt, Pd, Ru, Rh, Ir, Ag, Au, Os, Re, Cu, Ni, Fe, Cr, Mo, Co, W, Mn, Al, Zn, Sn, with more preferred metals being Ni, Pd, Ru, Pt, and the most preferred being Pt. In preferred embodiments, catalyzed active metal in the form of metal particles is attached to large carbon particles. Metal particle loading on carbon particles ranges from about 5% to about 80% (wt/wt %), but is preferably between about 20% and about 50% (wt/wt %). The carbon particles are typically high surface area carbon, such as Vulcan XC-72, XC-72R or Black Pearls 2000 available from Cabot, Billerica, Mass. Overall loadings of the catalyst layer depend on the electrode, type of fuel and operation conditions of the MEA and resulting fuel cell. Typically, Pt loadings on a membrane ranges from about 0.1 μg/cm² to about 1 mg/cm².

The fuel cell electrode may further contain at least one ionically conductive component to improve the surface area and reactivity of the catalyst layer in the resulting MEA. The ionically conductive materials in the electrode layers may or may not be of the same material as the ionically conductive membrane. Preferably, the conductive material in the electrodes is similar to the ionically conductive membrane material. Presently, the most commonly used ionic conductive membrane material are of the PFSA type.

The electrode may also, at least partially, include a hydrophobic material. Preferable materials are perflouronated type, such as polytetrafluoroethylene (“PTFE”). However, other hydrophobic materials may also be used. This component is typically added to help with the water management during fuel cell operation.

The present invention details a process, according to one embodiment of the present invention, in which a high performance MEA with good adhesion characteristics is produced. FIG. 3 shows an embodiment of a membrane structure that is processed to produce a catalyzed membrane, according to an inventive process. The described inventive processes, however, are preferably employed for producing a MEA incorporating a membrane having the general structure set forth in FIG. 4.

A first step in one embodiment of the inventive MEA assembly process includes mixing components of a catalyst to produce a mixture, which includes an aprotic solvent. Mixing in this step may include any one or a combination of sonication, mechanical stirring, high shear mixing, and homogenization.

In certain embodiments, the first step results in a prepared catalyst ink, which includes the aprotic solvent. The aprotic solvent in the catalyst mixture includes at least one member selected from the group consisting of N,N-dimethyl acetamide (“DMAc”), N-methyl-2-pyrrolidinone (“NMP”), dimethyl sulfoxide (DMSO“), polyvinylpyrrolidone (“PVP”), and N,N-dimethyl formamide (“DMF”). The catalyst mixture may contain between 0.0001% by weight and about 90% by weight of the aprotic solvent. It is believed that the presence of the aprotic solvent allows for effective partial dissolution of the membrane surface during application of the catalyst mixture to the membrane material and effective adhesion of the catalyst mixture to the membrane surface, both of which are not collectively achieved by conventional techniques.

The catalyst mixture of the first step may include other materials, such as a metal dispersed catalyst, an ionomer solution, and a dispersion agent. In one embodiment, the catalyst mixture contains about 0.5% by weight and about 80% by weight of the metal dispersed catalyst, about 0.1% by weight and about 60% by weight of the ionomer solution, and about 0.1% by weight and about 99% by weight of the dispersion agent.

Metal dispersed catalysts includes at least one member selected from the group consisting of supported or unsupported transition metals or transition metal alloys. The most preferable support material is carbon. The transition metals may be transition metals well known to those skilled in the art or transition metal alloys.

The composition of ionomer solution in the catalyst mixture depends on the ultimate formulation of the ionic conducting membrane. In one embodiment of the present invention, the ionomer solution includes at least one member selected from the group consisting of fluorinated, non-fluorinated and partially fluorinated compounds. In an alternative embodiment of the present invention, ionomer includes at least one member selected from the group consisting of aromatic and aliphatic compounds.

In those instances where a dispersion agent is present in the catalytic mixture, the dispersion agent includes at least one member selected from the group consisting of isopropanol, ethanol, methanol, butanol, n-butanol, t-butanol, glycerol, ethylene glycol, tetrabutylammonium hydroxide, diglyme, butyl acetate, dimethyl oxalate, amyl alcohol, polyvinyl alcohol, xylene, chloroform, toluene, m-cresol and water. The selection of the material to form the dispersion agent depends on the desired characteristics of the catalytic layer and the resulting MEA.

In other embodiments, the first step of the present invention produces a catalyst mixture includes at least one selected from the group consisting of a dielectric adjuster, a pore forming agent, a hydrophobic additive.

In preferred embodiments of the present invention, the various components of the catalyst mixture are mixed together to achieve a substantially homogenous mixture that minimizes agglomeration and settling.

Next, a second step of the process includes applying the catalyst mixture prepared in the first step to a membrane to produce a catalyzed membrane. Application techniques may include any one or a combination of spraying, painting, tape casting, dip coating, and screen printing.

In this step, loading of the metal dispersed catalyst in said catalyst mixture on said membrane is between about 0.001 and about 5 mg/cm². By way of example, such loading may be accomplished by electro-catalyst loading on a polymer electrolyte.

After application of the catalyst mixture, an optional step of drying may be carried out. In this optional step, layers of the catalyst mixture coated on the membrane are dried by placing the coated membrane in an oven to ensure that a substantial amount of the solvent in the catalyst mixture is removed. In preferred embodiments, this is accomplished by treating the coated membrane at a temperature that is between about 25° C. and about 250° C. for a duration that is between about 0.1 hours and about 35 hours. The resulting electro-catalyst layers should have thicknesses that is between about 0.5 μm and about 100 μm, and is preferably between about 0.5 μm and about 40 μm. Catalyst layers thinner than 0.5 μm are typically non-homogenous and irregular due to the film's porous nature. Additionally, catalyst thicknesses above 100 μm have a reduced permeability, increased resistance and dramatic reductions in catalyst utilization.

Another optional step includes compacting the dried membrane having coated thereon a catalyst mixture. By way of example, the catalyzed membrane is hot pressed at a temperature that is between about 25° C. and about 250° C. at a pressure that is between about 25 kg/cm² and about 200 kg/cm². In a preferred embodiment, however, this optional step is carried out at a temperature that is between about 100° C. and about 175° C. for a time period that is between about 5 seconds and about 120 minutes.

A yet another optional step includes treating the catalyzed membrane with an acidic solution. In preferred embodiments, this step of the present invention includes protonating acid sites of the ionomer in the MEA. The acid based solution includes at least one member selected from the group consisting of sulfuric acid, nitric acid, phosphoric acid, carboxylic acid, and hydrochloric acid. By way of example, the MEA is placed in an acidic solution having a concentration that is between about 0.000001 moles per liter and about 3 moles per liter between about 0.1 hours and about 5 hours at a temperature that is between about 25° C. and about 100° C.

A yet another optional step includes treating the catalyzed membrane with water. In this step, the MEA may be rinsed and soaked in water for a duration that is between approximately 0.25 hours and approximately 4 hours to remove a significant portion of the aprotic solvent. Remaining traces of the aprotic solvent may limit the performance and lifetime of the resulting MEA.

Assembly of the MEA entails sandwiching the catalyzed membrane between two electrodes, which are preferably gas diffusion electrodes. In one embodiment, gas diffusion electrodes used in the present invention are prepared by coating a carbon paper or a carbon cloth with a carbon-PTFE slurry, which is formulated as described below. A high surface area carbon powder, such as, Vulcan XC-72R (which is commercially available from the Cabot Corporation) is mixed thoroughly with water—isopropyl alcohol mixture (from about 1% to about 75% water by volume). Such mixing is accomplished by ultrasonication and mechanical stirring. Once the solution is substantially homogenous, a Teflon® suspension, such as DuPont's PTFE T30B may be added (about 10% to about 50% by weight) while stirring solution. In accordance with one preferred embodiment of the present invention, the carbon slurry is coated on carbon paper or carbon cloth substrate by spraying using a general purpose spray gun, for example. Other application methods include painting, tape casting, and printing. Such coating produces a substrate with a porous body, which is treated under vacuum or inert gas at a temperature that is between about 250° C. and about 350° C. for period that is between about 0.5 hours and about 4 hours. Carbon loadings that are between about 1 and about 10 mg/cm² are preferred to achieve the optimum gas diffusion performance.

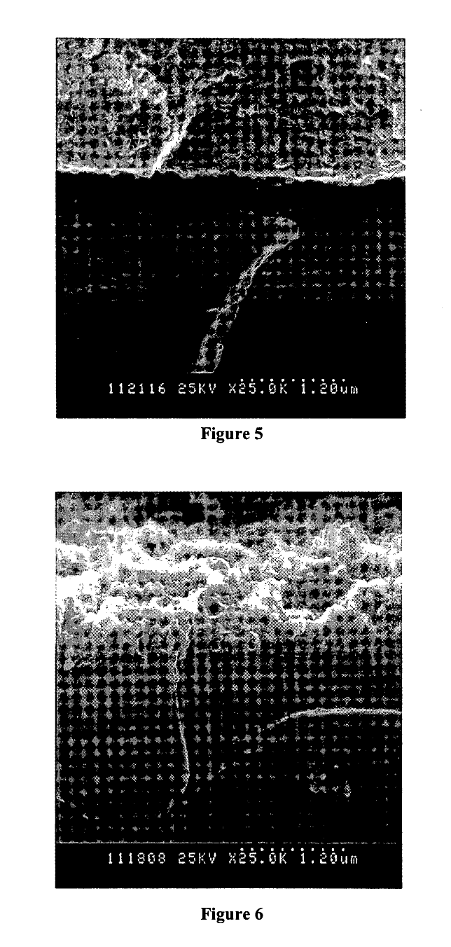

The described MEA assembly process exhibits good electrode-electrolyte adhesion compared to the conventional thermoplastic based MEAs. FIGS. 5 and 6 illustrate the extent of electrodes-electrolyte adhesion in such MEAs. The MEA used for comparison purposes in FIG. 5 is made by conventional techniques and the MEA used for comparison purposes in FIG. 6 is made using the above-described inventive process. The MEA made in FIG. 5 is made in the same manner as the one shown in FIG. 6 except the composition of the catalyst mixture does not contain any aprotic solvent. Both of these figures show that a catalyst coated membrane (“CCM”) produced from the inventive process, which includes using a mixture that contains an aprotic solvent, exhibits excellent electrode-electrolyte adhesion compared to the MEAs without the aprotic solvent. As a result, it is believed that the presence of the aprotic solvent in the catalyst mixture helps improve adhesion between the catalyst layer and the polymer surface.

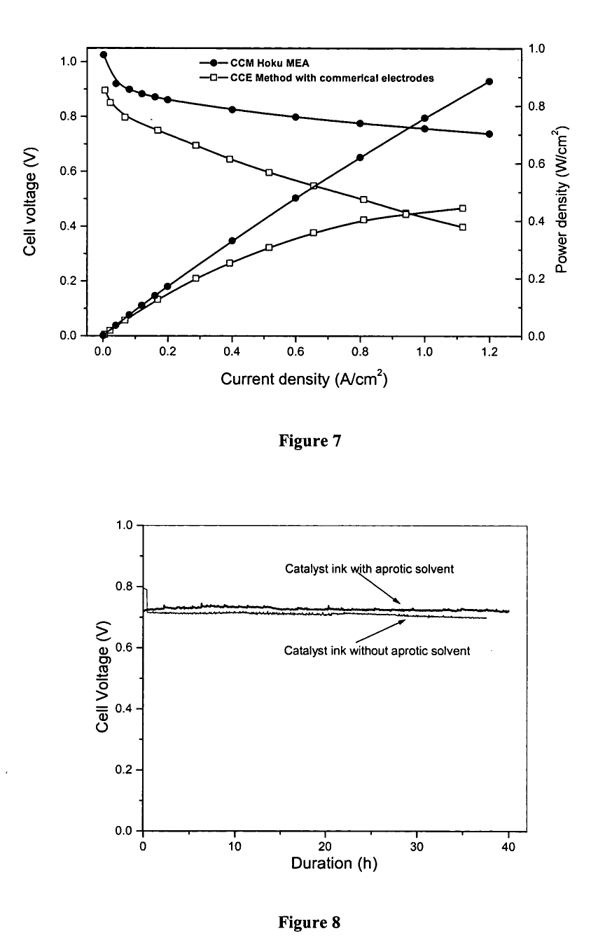

Fuel cell performance examples of MEAs fabricated with and without aprotic solvents are described in FIGS. 7 and 8. Tests were conducted using pure hydrogen and oxygen at about 80° C. at about 100% RH test conditions. As seen from FIG. 7, the described inventive methods impart higher catalytic activity due to the better electrolyte adhesion and interaction with the electrodes than the conventional methods. The interfacial resistance is also reduced for the MEA made with the described inventive methods as seen from the reduced voltage loss/drop at lower current densities. Activation polarization losses for the MEA produced from the inventive processes are very low in comparison with that of the MEA produced from the conventional processes. As a result of the improved catalyst mixture formulation, the resulting catalyzed membrane and MEA shows lower interfacial resistance compared to those with commercial catalyzed electrodes Accordingly, the power density values are higher for the MEA produced from the inventive assembly process than the MEA produced from the conventional assembly process.

FIG. 8 compares the fuel cell performance of CCM based MEAs fabricated using catalysts mixtures with and without an aprotic solvent at a temperature of about 80° C. using hydrogen and air at ambient pressure. The MEA produced from the inventive process with catalyst coated membrane exhibits higher cell voltage at 0.3 A/cm², which is attributed to better electrode-electrolyte adhesion.

Although the foregoing invention has been described in some detail in for purposes of clarity of understanding, it will be apparent that certain changes and modifications may be practiced within the scope of the apprehended claims. Therefore, the present embodiments are to be considered as illustrative and not restrictive, and the invention is not to be limited to the details given herein, but may be modified within the scope of the appended claims.

1. A process for producing a catalyzed membrane, comprising the steps of:
mixing components of a catalyst to produce a catalyst mixture, said components including an aprotic solvent;
applying said catalyst mixture to a membrane to produce said catalyzed membrane.

2. The process of claim 1, wherein in said step of mixing, said components further include at least one member selected from the group consisting of a metal dispersed catalyst, an ionomer and a dispersion agent.

3. The process of claim 1, wherein in said step of mixing, said components of said catalyst contain between about 0.0001% by weight and about 90% by weight of said aprotic solvent.

4. The process of claim 2, wherein in said step of mixing, said components of said catalyst mixture contain between about 0.5% by weight and about 80% by weight of said metal dispersed catalyst.

5. The process of claim 1, wherein said step of applying, said membrane is a proton conducting membrane.

6. The process of claim 5, wherein said step of applying, said proton conducting membrane is at least one member selected from the group of fluorinated, non-fluorinated, and partially fluorinated compounds.

7. The process of claim 5, wherein said proton conducting membrane is selected from the group consisting of aromatic and aliphatic based polymers.

8. The process of claim 1, wherein in said step of mixing, said components of said catalyst mixture contain between about 0.1% by weight and about 60% by weight of said ionomer.

9. The process of claim 1, wherein in said step of mixing, said components of said catalyst mixture contain between about 0.1% by weight and about 99% by weight of said dispersion agent.

10. The process of claim 1, wherein in said step of mixing, said aprotic solvent is at least one member selected from the group consisting of N,N-dimethyl acetamide (“DMAc”), N-methyl-2-pyrrolidinone (“NMP”), dimethyl sulfoxide (“DMSO”), polyvinylpyrrolidone (“PVP”), and N,N-dimethyl formamide (“DMF”).

11. The process of claim 1, wherein said step of mixing produces a substantially homogenized catalyst mixture.

12. The process of claim 2, wherein in said step of mixing, a metal in said metal dispersed catalyst includes at least one member selected from the group consisting of supported and unsupported transition metals.

13. The process of claim 2, wherein in said step of mixing, said metal dispersed catalyst includes at least one member selected from the group consisting of transition metals and transition metal alloys.

14. The process of claim 2, wherein in said step of mixing, said ionomer includes at least one member selected from the group consisting of fluorinated, non-fluorinated and partially fluorinated compounds.

15. The process of claim 2, wherein in said step of mixing, said ionomer includes at least one member selected from the group consisting of aromatic and aliphatic compounds.

16. The process of claim 2, wherein in said step of mixing, said dispersion agent includes at least one member selected from the group consisting of isopropanol, ethanol, methanol, butanol, n-butanol, t-butanol, glycerol, ethylene glycol, tetrabutylammonium hydroxide, diglyme, butyl acetate, dimethyl oxalate, amyl alcohol, polyvinyl alcohol, xylene, chloroform, toluene, m-cresol and water.

17. The process of claim 2, wherein in said step of mixing, said components of said catalyst includes at least one member selected from the group consisting of a dielectric adjuster, a pore forming agent, a hydrophobic additive.

18. The process of claim 1, wherein said step of mixing includes at least one technique selected from the group consisting of sonication, mechanical stirring, high shear mixing, and homogenization.

19. The process of claim 1, wherein said step of applying includes at least one technique selected from the group consisting of spraying, painting, tape casting, dip coating and screen printing.

20. The process of claim 1, wherein in said step of applying, loading of said metal dispersed catalyst in said catalyst mixture on said membrane is between about 0.001 and about 5 mg/cm².

21. The process of claim 1, further comprising drying said catalyzed membrane.

22. The process of claim 16, wherein said drying is carried out at a temperature that is between about 25° C. and about 250° C.

23. The process of claim 16, wherein said drying is carried out for a duration that is between about 0.1 hours and about 35 hours.

24. The process of claim 16, wherein said drying produces a catalyst layer having a thickness that is between about 0.5 μm and about 100 μm.

25. The process of claim 1, further comprising compacting said catalyzed membrane to produce a resilient catalyst layer.

26. The process of claim 25, wherein said compacting includes hot pressing said catalyzed membrane at a temperature that is between about 25° C. and about 250° C. at a pressure that is between about 25 kg/cm² and about 200 kg/cm².

27. The process of claim 1, further comprising of treating said catalyzed membrane with an acid based solution.

28. The process of claim 27, wherein said acid based solution includes at least one member selected from the group consisting of sulfuric acid, nitric acid, phosphoric acid, carboxylic acid, and hydrochloric acid.

29. The process of claim 27, where in said acid based solution has a concentration that is between about 0.000001 moles per liter to about 3 moles per liter.

30. The process of claim 1, further comprising treating said membrane with water.

31. A membrane electrode assembly for fuel cell application, comprising a catalyzed membrane produced by steps including:
mixing components of a catalyst to produce a catalyst mixture, said components including an aprotic solvent; and
applying said catalyst mixture to a membrane to produce said catalyzed membrane.

32. The membrane electrode assembly of claim 31, wherein said catalyzed membrane is sandwiched between a cathode and an anode.
